(19) United States
(12) Patent Application Publication
(10) Pub. No.: US 2022/0355368 A1
(43) Pub. Date: Nov. 10, 2022

(54) METHOD FOR PRODUCING A CASTING MOLD AND MOLD PRODUCED USING THE METHOD

(71) Applicant: Fraunhofer-Gesellschaft Zur Förderung Der Angewandten Forschung e. V., München (DE)

(72) Inventors: Daniel Günther, Augsburg (DE); Florian Ettemeyer, Augsburg (DE)

(21) Appl. No.: 17/620,957

(22) PCT Filed: Jun. 19, 2020
(86) PCT No.: PCT/EP2020/067242

§ 371 Date: Dec. 20, 2021

(30) Foreign Application Priority Data
Jun. 21, 2019 (DE) 10 2019 209 047.8

(51) Int. Cl. B22C 7/02

(52) U.S. Cl. CPC B22C 7/02

(57) ABSTRACT

The invention relates to a method for producing a casting mold (201,204), according to which at least three, in particular at least four, five, more than five, or more than ten sandwich elements (300, 301, 302, 400, 401) of the casting mold are first produced separately from one another and are then combined into one or more stacks (1100) to form the casting mold.

### CROSS REFERENCE TO RELATED APPLICATIONS

The present application is a national stage application of International Application No. PCT/EP2020/067242, filed Jun. 19, 2020, which claims priority to German Application No. 102019209047.8, filed Jun. 21, 2019, the disclosures of which are hereby incorporated by reference in their entireties.

### FIELD OF THE DISCLOSURE

The invention is in the field of mechanics, mechanical engineering and foundry technology. Said invention can be used with particular advantage in the production of casting molds, its use in large casting molds, for example, in the construction of houses, parts of houses or other large components, being just as conceivable as in casting molds for small parts. In addition, the casting molds produced can be used for casting processes with many different casting materials.

### BACKGROUND OF THE DISCLOSURE

Basically, so-called lost molds and permanent molds with and without cores are known as casting molds for the production of cast components. Lost molds enable particularly complex cast products based on the decanting molding process, which is based on the destruction of the molds. Internal structures of the casting molds can be implemented using cores that define cavities during casting and can be destroyed and removed using various methods after the casting material has solidified. Corresponding casting molds and cores can be produced, for example, using the sand casting molding process, in which sand is mixed with a binder and shaped with the aid of a tool.

Additive manufacturing processes are also known for producing casting molds which processes allow the molding of complex bodies with great freedom of design in a layered structure. In this process, particles are applied in layers to a platform and selectively solidified, for example, by the targeted addition of binder material or by laser sintering. The disadvantage of such methods for producing casting molds is their high costs and long production times.

### SUMMARY

Against the background of the prior art, the present invention is based on the object of developing a method for producing a casting mold and a casting mold which are structured as simply as possible, take little effort and are inexpensive, thereby allowing the production of complex casting molds.

The object is achieved by a method for producing a casting mold having the features of the claims. The claims also show embodiments of such a method and relate to a casting mold produced according to the method.

Accordingly, the invention relates to a method for producing a casting mold, in which initially at least three, in particular at least four, five, more than five or more than ten laminate bodies of the casting mold are produced separately from one another and then joined together into one or more stacks to form the casting mold.

The above-mentioned method also allows the production of complex casting molds which can be composed of laminate bodies in layers, the individual laminate bodies being able to be produced in various processes with little effort.

The model of a casting mold can thus first be broken down into layers, and the laminate bodies that form the individual layers can be produced individually and separately from one another. The laminate bodies are then assembled such that cavities in each of the individual laminate bodies share the interior, that is, define the cavity of the mold to be filled with a casting material. By dividing the casting mold into laminate bodies, complex casting molds can also be assembled from laminate bodies, each having simply designed cavities or openings.

The individual laminate bodies are joined together into a stack to form the casting mold. The stacking direction is the direction in which the stack grows by adding further laminate bodies. The direction that is perpendicular to the boundary surfaces between the individual laminate bodies that have been joined together can also be referred to as the stacking direction.

A casting mold can be assembled from a single stack of laminate bodies, but a plurality of stacks of laminate bodies can also be or are connected into a casting mold, wherein the different stacks can, for example, be arranged next to one another, one behind the other, one on top of the other or a stack can also be arranged within a cavity of another stack.

One embodiment of the invention can provide that after the assembly into the casting mold, several laminate bodies, in particular each laminate body with the exception of the end laminate bodies of a stack, each surround the cavity of the casting mold to be filled with a casting material in an annular manner. For example, a casting mold for a ball can be assembled from a plurality of laminate bodies such that the casting mold is designed in the shape of a cube in its outer contour, with each layer of the cube having a circular, through recess and the recesses jointly defining the spherical cavity after the casting mold has been assembled. In each laminate body, the circular recess is surrounded by an annular wall having an approximately cylindrical contour on its inside and straight boundary walls on the outside. The end laminate bodies of the stack, which define the mold described, then have no through recesses, but only dome-shaped depressions that delimit the spherical cavity.

A further possible embodiment of the method can provide that several laminate bodies, in particular each laminate body with the exception of the end laminate body of a stack, each has/have at least one opening which completely penetrates the laminate body and is surrounded by a circumferential laminate body wall. Depending on the shape of the individual laminate bodies and the shape of the cavity for the actual casting, the laminate body walls have circumferentially varying thicknesses. For example, the laminate bodies can be in the form of cuboids or flat or curved plates, the plates being able to be designed, for example, round, square, rectangular or polygonal.

The method can also be designed such that the laminate bodies are aligned when said laminate bodies are joined together into a stack on a common alignment body or by interlocking projections and recesses provided on each of the laminate bodies. This design of the laminate bodies and, optionally, of an alignment body can ensure that the laminate bodies with their recesses are positioned relative to one another such that the recesses as a whole define the casting mold, that is, also the mold cavity to be filled with the casting material.

The alignment body can be formed, for example, by a straight rod or plate on which the outer contours of the laminate body are laid out. The laminate bodies can, for example, also have through bores through which an alignment body can be inserted. The elevations and recesses on the laminate bodies can be designed, for example, as grooves and webs or bores and pegs in order to align adjacent laminate bodies with one another.

A further embodiment of the method can provide that the laminate bodies are connected to one another at the adjacent boundary surfaces when said laminate bodies are joined together into a stack and either have the same layer thickness or different layer thicknesses in the stacking direction. Since the laminate bodies are produced separately from one another, they have to be connected to one another after production, unlike in the known additive manufacturing processes. In some cases, a form-fitting joining together with alignment bodies can be sufficient, while in other cases, the laminate bodies are glued or welded to one another. Magnetic adhesion to one another or other known joining techniques between the laminate bodies are also conceivable. Ultimately, the laminate bodies can also be clamped to one another by springs or clamps in order to be connected to one another in a force-locking manner in this way.

The laminate bodies can each have the same thickness, which facilitates the production of the laminate bodies in larger numbers. However, it can also be useful to process different laminate bodies or laminate body groups with different layer thicknesses in a stack within a casting mold in order to set the correct dimensions for the casting mold or for parts of the casting mold in this way. For example, it can be useful to form certain sections of the casting mold with as few laminate bodies as possible, while other parts/sections of the casting mold are composed of a larger number of laminate bodies having a smaller layer thickness. This can be the case, for example, if the dimensions of the casting mold in the stacking direction vary very strongly in some sections and less strongly in other sections.

The method can also be designed, for example, in that the laminate bodies are connected to one another when they are joined together by gluing, welding or by a force-fit or form-fit connection.

It can also be provided that the laminate bodies are produced by an extrusion process, a rolling process, a casting process, a core shot process or an additive manufacturing process.

For example, it can be provided that the laminate bodies are produced as solid bodies and that a recess penetrating said laminate bodies is then made in a plurality of laminate bodies, in particular in each of the laminate bodies.

In principle, all machinable materials can be considered as materials for the laminate bodies. For example, the laminate bodies can be produced from a plastic, a metal or also from a bonded sand material, as is usually used in the production of lost casting molds. Depending on the materials used, the machining methods that are used are then adapted to produce recesses in the laminate bodies, which later each form part of the casting mold/cavity for the casting material.

For this purpose, it can be provided, for example, that recesses penetrating the laminate bodies are made in said laminate bodies by means of a subtractive, in particular a cutting process, by punching, laser cutting, water cutting or by a chemical process. In addition to sawing, milling, for example, is also conceivable as a machining method. Machining by drilling, grinding, planing, flame cutting, compressed air blasting, sandblasting or eroding is also possible. If the cohesion of particles of the laminate bodies is suitably adjusted, parts of the laminate bodies can also be removed by using negative pressure/suction. A targeted reversal of magnetization can at least facilitate the process of subtractive machining when using magnetic particles as the base material for the laminate bodies.

With regard to the shape of the laminate bodies and/or the stack of laminate bodies, it can be provided that the laminate bodies are designed in the form of disks or as plane-parallel plates.

It can also be provided that the surfaces of the laminate bodies of a stack which adjoin adjacent laminate bodies are coplanar.

The maximum angle that two mutually opposite boundary surfaces of a laminate body form with one another should be limited and be less than 30 degrees, in particular less than 10 degrees, further in particular less than 1 degrees, so that the stacking direction or the alignment of the individual laminate bodies over the height of the stack does not vary too much and cohesion of the laminate body can be made possible in a simple manner. In some constellations, it can be advantageous to provide a number of wedge-shaped laminate bodies which follow one another in the stack in the opposite wedge direction or in an alternating wedge direction.

The method can also provide that each of the laminate bodies is free of undercuts in the stacking direction. The production of the individual laminate bodies is facilitated in this way, since, for example, machining can follow from one side of the laminate body in a simple manner. If undercuts are to be provided in the stacking direction in the cavity of the casting mold, then these undercuts can be implemented at least partially through the interfaces of the laminate bodies.

In the method, for example, it can be provided that the laminate bodies are designed and joined together such that, in the stacking direction, at least one undercut is provided in the cavity of the casting mold to be filled with a casting material and is formed by an interface of a laminate body.

In addition to the method steps used directly to produce the laminate bodies and the casting mold, the method can also comprise a planning step, the planning being based on a model of the casting mold and said model being tentatively divided into one or more stacks of laminate bodies in a plurality of stacking directions. The selection of the stacking direction and optionally also the layer thickness of the laminate bodies can be made according to various optimization criteria. For example, the number of laminate bodies in the casting mold can be minimized, or the unevenness resulting from the interfaces between the laminate bodies in the casting mold can be minimized. The position of the undercuts in the casting mold can also be optimized in this way.

It can be provided, for example, that a model of the casting mold is divided into layers one after the other in different stacking directions and the stacking direction having the smallest number of undercuts is selected and that, in particular, the layer thicknesses of the laminate bodies are then divided so that all undercuts at the interfaces lie between each two layers. Should it not be reasonable or possible to localize all undercuts at the interfaces between two different laminate bodies, the aim can at least be to localize as large a number of undercuts as possible at the interfaces so that undercuts only have to be created in a few of the laminate bodies.

Ultimately, the invention relates not only to a method for producing a casting mold, but also to a casting mold produced using the method.

### BRIEF DESCRIPTION OF THE DRAWINGS

In the following, the invention is shown on the basis of embodiments in figures of a drawing and is explained below. In the drawings:

FIG. 1 shows a cast component in a perspective view;

FIG. 2 schematically shows a casting mold for a cast component according to FIG. 1 in a cross-section;

FIG. 3 shows, in section, a casting mold similar to that depicted in FIG. 2, which is formed from a number of laminate bodies by stacking;

FIG. 4 shows a casting mold in cross-section which is formed by laminate bodies having variable layer thicknesses;

FIG. 5 shows a laminate body having two recesses which, after the casting mold has been assembled, each form a part of the cavity to be filled with casting material;

FIG. 6a shows a laminate body in cross-section with a schematic representation of the recesses to be made therein;

FIG. 6b shows a laminate body in cross-section with a schematically depicted milling cutter in an orientation of the milling axis perpendicular to the boundary surfaces of the laminate body;

FIG. 6c shows a representation as in FIG. 6b with an inclined milling cutter;

FIG. 6d shows a representation as in FIG. 6c with two milling cutters which, without an inclined position, create the recess in the laminate body in a step-like manner from both sides;

FIG. 7a shows the production of a laminate body by a rolling process;

FIGS. 7b and 7c shows the production of a laminate body in a press or core shooting process;

FIG. 8 shows joining and pressing different layers together;

FIG. 9 shows a casting process in which a stack of laminate bodies is held together by weight;

FIG. 10 shows a casting process in which the laminate bodies of a stack are clamped together;

FIG. 11 shows a casting mold composed of different stacks of laminate bodies;

FIG. 12 shows a casting mold similar to that depicted in FIG. 3, but with the stacking direction of the laminate bodies being rotated by 90 degrees;

FIG. 13 shows, in cross-section, a stack of laminate bodies having a plurality of wedge-shaped laminate bodies;

FIG. 14 shows, in cross-section, a stack of laminate bodies having recesses for alignment bodies; and

FIG. 15 shows a perspective view of a laminate body having elevations for interlocking with the adjacent laminate body.

### DETAILED DESCRIPTION OF THE DRAWINGS

In the following, various methods for producing molds for components produced by casting are described using a layer-by-layer build-up process, one layer being prepared in each case in the form of a laminate body, cavities being introduced into the laminate body according to the cast part cross-section and the laminate bodies produced in this way being stacked until the desired shape is completely stacked. This provides a build-up process for casting molds, which is also possible without tools and which enables the economical production of even larger series of components.

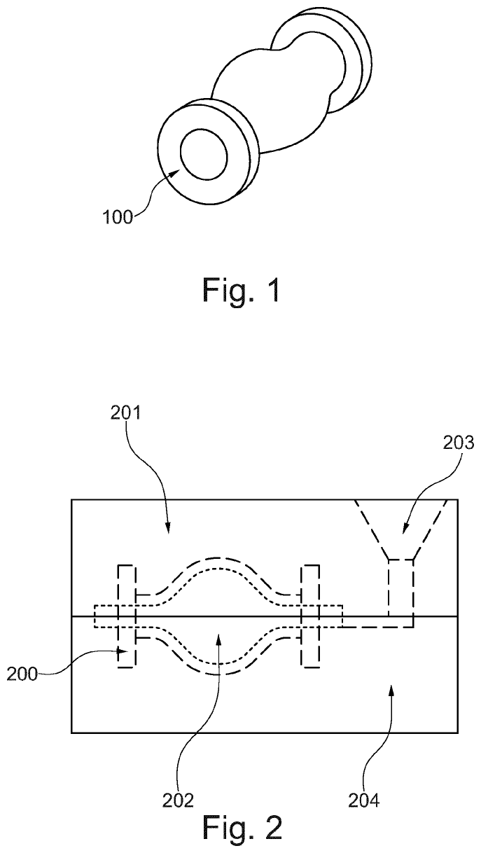

A typical component 100 that can be produced as a cast part is depicted in a perspective view in FIG. 1. The method produces casting molds that are suitable for small parts on a scale of a few liters, volumes, but also for large components. The casting material is not restricted and can come from the groups metals, ceramics, polymers, natural substances and mixtures thereof.

The components 100 produced via molding with the aid of the method according to the invention correspond in one embodiment to the unmachined raw casting known in the prior art. In this case, they represent an intermediate state and usually have to be completed by a further processing step, for example, milling or grinding on the functional surfaces.

The aim of the invention is to provide a method for producing molds which makes it possible to produce cast components 100 in a short time, in particular without tools, economically and with very few restrictions in terms of shaping.

The casting molds produced by the method according to the invention can be used widely in industry. The application ranges from the casting of large individual pieces to large-scale production in the automotive industry.

Metals can be poured in liquid form, but also materials such as plastics, concrete or ceramic slurry.

The procedure for casting can be very different: Pressure can be caused by the weight of the melt, as in gravity casting. However, there are also processes in use that favor mold filling through significantly increased pressure. This is the case, for example, with die casting when particularly thin wall thicknesses are to be achieved.

In all casting processes, it is important to use a tool in the form of a casting mold, as depicted by way of example in FIG. 2. The casting mold depicted there can be used, for example, to produce a component depicted in FIG. 1. The casting mold, composed of a mold 201, 204 (outer contour) and a core 202, can be used for a single use (lost mold) or for many casts (permanent mold). In addition to the mold cavity 200, the cavity for receiving the casting material, a gating system with a pouring basin and gate 203 must also be provided in the casting mold.

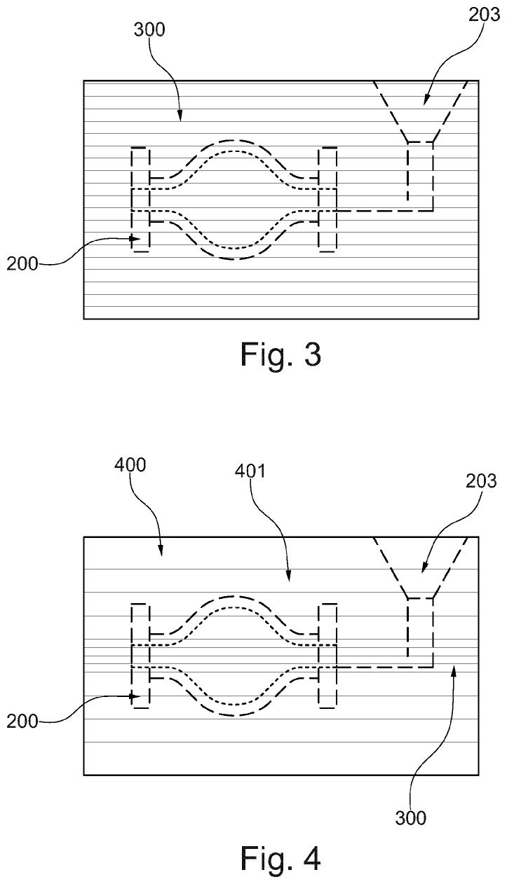

The method according to the invention is a layered construction method providing a casting mold 201, 204 for a casting method and optionally also one or more cores. As shown in FIG. 3, laminate bodies 300 are individually prepared and stacked on top of one another. In one embodiment, the method according to the invention has the following steps:

In the first step, the cast component 100 to be produced is virtually placed in the installation space. In doing so, the construction position that can best be mapped using the method is determined. Then the component 100 is tentatively divided into possible laminate bodies 300 via a program, and a machining image is generated for each laminate body 300 depending on the layer generation mechanism and stacking direction. The calculation method used minimizes the creation of artifacts through digitization and reduces their effect on the shape of the desired mold. The stacking direction corresponds to the direction in which the laminate bodies are arranged one above the other. The direction of stacking can also be defined as the direction that is perpendicular to the interfaces between the laminate bodies or, if, for example, some wedge-shaped laminate bodies are provided, an averaged direction of all perpendiculars on the interfaces between adjacent laminate bodies.

The laminate bodies 300 are produced after the casting mold has been divided. These are produced as closed plates from a molding material adapted to the planned casting material. The result of this process step is compressed plates of molding material.

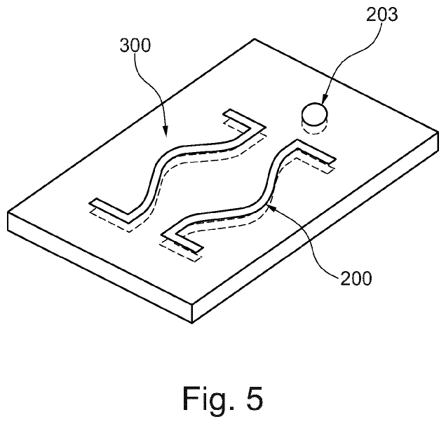

These are machined in a further step, and the contours of the component at the respective cutting height at which the respective laminate body is positioned in the mold are introduced into the respective laminate body in the form of recesses. This can be seen clearly in FIG. 5.

The casting mold 201, 204 is now completed by stacking and connecting the individual laminate bodies and can be used in a conventional casting process.

The starting point for the method according to the invention is the component 100 having a cast construction that can be used for a casting process. This usually provides a gate system, air channels, feeders and a system for pouring the liquid. According to the prior art, such a system is determined and tested by means of a simulation before the production of the mold 201, 204.

This virtual construction is analyzed for processing in the method according to the invention in an automated method in a data processing device and tested in a simulation. This takes into account the property of the method that layers are not produced where they are to be placed during later use, as is the case with conventional 3D printing processes, but are prepared as laminate bodies outside the actual installation space of the machine and then transferred to an installation space. The algorithm optimizes the individual layers such that no loose layer parts arise. Second, the algorithm can give preference to certain construction locations in which the stratification is reduced in relevant regions.

This optimization cannot only take place on the basis of the rotation of the stacking direction with respect to the component 100. As depicted in FIG. 4, different layer thicknesses can also be used within a stack, that is, different heights of the laminate body are used. In this way, regions requiring high resolution due to strong curvatures of the mold, for example, can be imaged with thin laminate bodies 300, 400, 401. The program can also make suggestions to the user that represent compromises between manufacturing time, component quality and resource consumption.

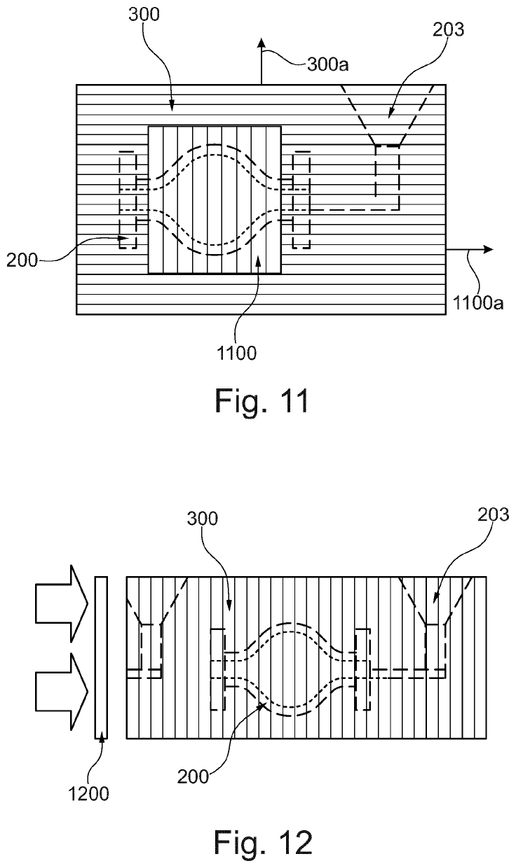

In a component 100, as shown in FIG. 11, the digital generation of the layers can result in a plurality of regions having different stacking directions. These regions can be cube-shaped or shaped like a spatula. The stacks 1100 themselves can have different stacking directions in order to reduce negative effects of the stacking direction on the component surface to be cast. The stacking direction of the inner stack 1100 is designated by 1100a in FIG. 11, while the stacking direction of the outer stack is designated by 300a.

The laminate bodies 300, 400, 401 themselves must be transportable for relocation into the installation space. In known molding materials for various casting processes, layers that are greater than 1 mm thick can be considered for this in many cases. There is no upper limit to the thickness of the layers and in practice it is only set by the layer machining method.

The method is based on laminate bodies made of molding material. The laminate bodies can be pre-produced for the method, but they can also be produced individually in a production line by means of the method steps required for the method. Layer generation can take place in a highly parallel and highly automated manner, achieving high throughputs.

The material of the laminate body depends on the desired casting process: Sawdust, for example, is a simple material and inexpensive waste material. This can be used for forms 201 for processes that have low heat build-up. Other materials such as plastic waste, straw, scraps of paper or wood chips can also be considered for such an application. If higher requirements are placed on the molding material, other materials can be used; for example, metal powder or metal granules can be used as molding material. There are various advantages and disadvantages, depending on the casting material. Molding sand, ceramic sands and special molding materials are used when there are strong temperature effects such as in iron and steel casting. Graphite can also be used for materials that have a high melting temperature.

The shape of the particles can be varied from a free grain distribution to geometrically defined particles. An extreme case would be a natural bed in the molding material layer, which consists of a mixture of particles having a specific grain size distribution. Another extreme would be a laminate body of puzzle-piece-like elements that can be connected to one another.

The laminate bodies can be produced individually or as a strand. The strand can run over a conveyor belt and be machined or cut to length with the aid of so-called flying tools or brought to a specified format.

The laminate body 300 itself can be composed of a loose, moldable molding material and a binding system. The binding system can be based on different mechanisms: For example, sand can be mixed with a clay-containing binding agent that can swell with water. Such a system can be formed into a loadbearing laminate body 300 by purely mechanical compression. Tamping, blowing in or rolling can be considered for compaction. Chemical binders are also known from metal foundry technology. These binders are added to the sand and harden it through a polymerization reaction. Molding material binders are also known In this context in which physical hardening takes place via drying. The binder system can be mixed in via mechanical mixers prior to forming into plates. It is also possible to apply the binder over a large area using spray systems or inkjet print heads. Special forms of binding are magnetic particles or the mechanical connection already described above via a specific particle geometry. Depending on the moisture content, it can be useful to produce the laminate bodies 300 by pouring a liquid molding material.

Various methods for producing blanks for laminate bodies are shown schematically in FIGS. 4a to 4c.

FIG. 4a depicts a rolling method in which a material emerges from a shot nozzle 701 and is guided past a roller 700 so that a smoothed layer is present behind the roller.

FIG. 4b shows a pressing method in which a material is pressed into the shape of a plate by the action of force under a press 704.

FIG. 4c shows a shooting method in which compressed air and molding material 707 are shot through a shot nozzle 705 under a striker plate 706 into a box in which a plate is formed. The compressed air 708 can escape through exhaust air openings.

When preparing for the machining method for the individual laminate bodies, it may be necessary to provide a structure in the laminate bodies 300 which makes it possible to transfer and handle laminate bodies in which the machining can result in loose or free regions that are not directly associated with the respective laminate body, but should be held and positioned in the casting mold thereby. Such a structure can be, for example, a mesh or a wire that is inserted into the laminate body 300 during manufacture. Depending on the machining method of the laminate bodies 300, it can be useful to position such a mesh or a wire in the middle of the laminate bodies 300 or at their edges.

The mesh/wire can be made of different materials. For example, the mesh or wire can be designed such that they form a unit with the cast material, since they consist of the same material or a similar composition as the cast part to be produced. However, it is also conceivable that the mesh or the structure consists of a material that reinforces or stiffens the cast body.

The laminate bodies formed in this way are plate-shaped and, depending on the position and use in the installation space, have vertical or inclined edges.

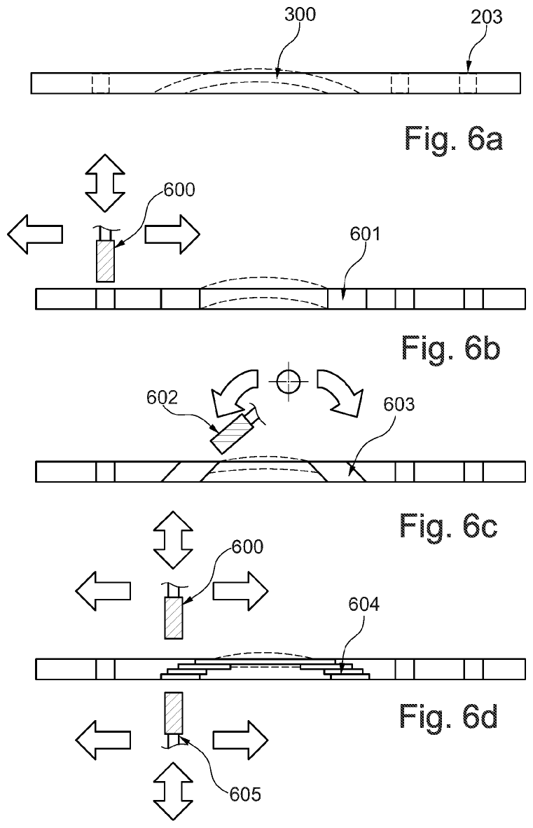

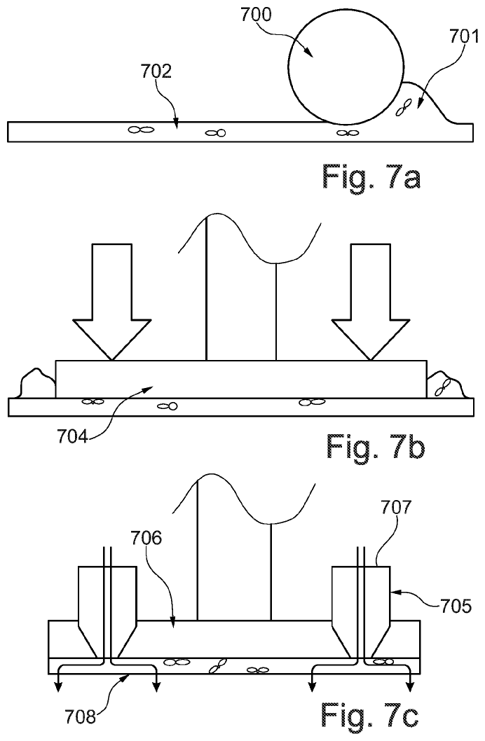

In the following step, the mold cavity 200 is created in the respective laminate body 300. Subtractive methods are used for this purpose, as is explained by way of example with reference to FIGS. 6a to 6d. This method removes individual regions from the pre-produced laminate body 300. The laminate body is advantageously free of undercuts viewed in the stacking direction or in another direction from which the laminate body can be machined, for example, using a milling cutter.

All conceivable processes that can remove molding material and can be simultaneously controlled automatically are suitable for machining. Milling is an example of such a process. Here, molding materials that have hardened, that is, have high strengths, can be machined.

In the region of the casting mold, that is, in the region of the recesses, the laminate bodies can have structural features, such as notches and draft angles, which allow the cast body to be produced to be reliably removed from the mold even with difficult material pairings.

A laminate body 300 is shown in FIG. 6a by way of example, in which part of the mold cavity depicted in dashed lines is to be produced. As shown in FIG. 6b, the milling can be carried out vertically using a cylindrical end milling cutter 600. As a result, layers can thus be produced which essentially correspond to prismatic extrusions in the direction of the stacking direction.

Vertical milled grooves are designated by 601 in FIG. 6b. In order to achieve better, also inclined surfaces on the final cast part, it is also expedient according to the invention to tilt the milling cutter 600 relative to the vertical, as shown in FIG. 6c.

Inclined milled grooves are denoted by 603 in FIG. 6c. The bevel on the mold cavity 200 then reproduces the component contour much better than a contour generated stepped using a straight milling cutter. This effect can be further improved if the laminate body 300 is machined from above and from below.

FIG. 6d depicts the machining of a laminate body from above and below by means of a vertical milling cutter, by which a stepped contour 604 can be produced. Form cutters represent a further improvement. Three-dimensional path control of the milling cutter 600 is also possible in order to reproduce the shape contour more precisely, but said path control is associated with greater effort.

As with milling, other methods known from metal-cutting shaping can be used. These include drilling, sawing, grinding, planing, lasering, flame cutting, water jet cutting, compressed air blasting, sandblasting or eroding. For thin and solid molding material sheets, it is also possible to produce the mold cavities by punching or fine blanking. For very loose or not yet hardened molding material, the unbound material can also be suctioned off in a targeted manner. Likewise, molding material parts can easily be removed using negative pressure in the case of a mechanical binding mechanism. A targeted reversal of magnetization is expedient when using magnetic base material for ablation or to support the ablation.

In addition to using mesh structures or wire in the interior of the layer 300, it can be expedient to introduce structures that additionally increase the structural strength of the layer 300. An example can be specially shaped meshes, grids, rods or other reinforcements. This is particularly necessary with large layers and molds that weigh several hundred kilograms or several tons. It can also be useful to provide transport aids for the layers. These can be in the form of eyelets or forklift pockets. Honeycomb structures or pockets can reduce the weight and can be implemented in the laminate bodies 300 outside the region of the mold cavity 200.

After their production, the laminate bodies produced are stacked into a casting mold 201. They are placed face to face in the correct order to do this. Said stacking can preferably take place perpendicular to the direction of gravity, so that the direction of stacking runs parallel to the effective direction of gravity.

However, stacks at any desired angle to the direction of gravity are also conceivable. It is also possible, as depicted in FIG. 11, to insert a package 1100 having a layer stacking into a package having another layer stacking having a different layer stacking direction.

Various mechanisms can be used to join together a mold 201 from the laminate bodies. The simplest method is to lay the layers on top of one another and use gravity as a connecting force. Depending on the density of the molding material and the casting medium, it may be necessary to weigh down the casting mold 201 with weights 900 before casting, as shown in FIG. 9. After the weighting, a liquid casting material/a melt 902 can be poured into the mold by means of a ladle 901 via the gating system.

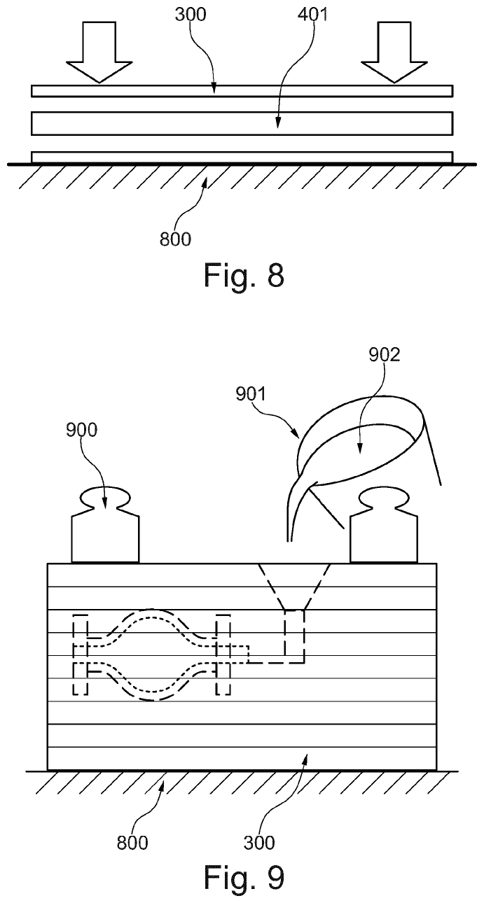

Likewise, the compacted laminate bodies 300, 401, as depicted in FIG. 8, can be pressed with one another or together against a support/base plate 800 and thus joined together. Here, for example, swellable binding clays on the surface of the laminate bodies 300, 401 or adhesives can be used.

Fibers can also be used on the surfaces of the laminate bodies 300, 401 in the sense of a Velcro fastener system.

Such systems can be attached to the top and bottom of the laminate bodies 300, 401 during laminate body production.

The laminate bodies can also be connected via physical and chemical binders. As with the binding of the molding material, many systems are known here and can be borrowed from metal casting technology, for example. An example can be resin-coated sand, the shell of which melts when exposed to heat. The laminate body 300, 401 to be joined is heated flat on its bottom and immediately pressed with the laminate body 300, 401 lying beneath it. The laminate bodies connect when the resin coating cools down. Likewise, the laminate bodies can also be sprayed with a chemically hardening adhesive, thus producing a layered composite.

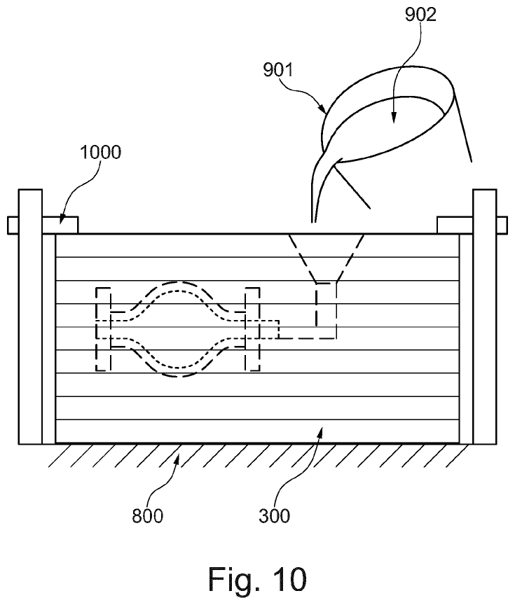

The laminate bodies can also be clamped, as shown in FIG. 10 using the low tensioner 1000. This can be done in layers or over a larger number of laminate bodies. Entire layer packages or the entire mold 201 can be connected in this way. Holes in the laminate bodies can also accommodate screws or bolts that grip into special dowels or threaded bores in the top and bottom laminate bodies, thus allowing screwing to a mold.

Similar to layer packages, bodies can be placed in the resulting mold 201 during the layer stacking. These can be various reinforcements, inserted casting molds or cores, functional elements (for example, controls, actuators), fibers, preprocessed constructions, cooling irons, cast parts or pipe systems.

A casting mold is shown as an example in FIG. 12, the stacking direction of which is perpendicular to the casting mold depicted in FIG. 9. In addition, FIG. 12 depicts a layer 1200 for the vertical installation of the laminate bodies as an alignment body.

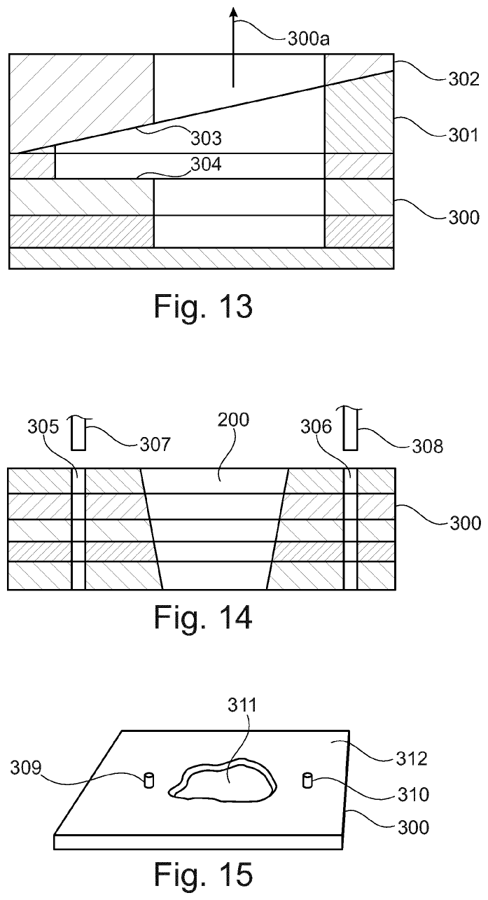

FIG. 13 depicts a casting mold in cross-section which, in addition to a plurality of plate-shaped laminate bodies 300, also has two wedge-shaped laminate bodies 301, 302. The wedge-shaped laminate body 301, 302 defines an undercut 303 in the casting mold through its interface. A further undercut surface 304 is formed by a planar laminate body 300. The stacking direction is designated by 300a in FIG. 14.

FIG. 14 shows a casting mold having a frustoconical mold cavity. The laminate bodies 300 each have two through bores 305, 306, which are aligned with one another and are aligned on the peg-shaped alignment bodies 307, 308 in that the alignment bodies are inserted into the bores.

FIG. 15 depicts a perspective view of a laminate body 300 having a recess and a surrounding laminate body wall having two peg-shaped elevations 309, 310 on the laminate body wall for interlocking with an adjacent laminate body having corresponding recesses.

The molds of large cast parts can be post-treated in order to improve the surfaces. This can be done, for example, by grinding down the gradation that occurs on the molds. The mold 201 can also be smoothed inside using blasting media.

The casting molds produced in this way can be used in all known casting processes. This includes, for example, gravity casting with metals. Metals such as aluminum, iron or steel can be processed here. However, it is also possible to cast concrete parts or use them in the region of plastic parts.

### Application Example

A bridge geometry over a pond is required for a horticultural project. The treads should be implemented with the aid of boards. The edges to the left and right of the steps are implemented by means of a topology-optimized lightweight structure, with different parts being connected to one another by individual support struts. The installation space of this structure is 900×600×600 mm³. The design of the bridge was calculated using mathematical optimization algorithms and does not exist in the form 201 of a physical model.

The bridge structure should be made of bronze for aesthetic reasons. A casting process is selected as the manufacturing process due to the very high complexity of the support structures. The foundry commissioned for this project sees the high level of complexity and opts for the method described above based on the favorable cost structure.

In preparation for the production of the mold, the bridge geometry is placed in a virtual installation space and automatically rotated such that when the geometry is dissected into individual layers, all laminate bodies are free of undercuts and each form a coherent body. The laminate bodies are automatically laid out as thick as possible and as thin as necessary. The angle of rotation and the tilting of the component 100 in the installation space are derived from the program for the foundry, so that a casting system can be designed and simulated for this geometry. The overall model with the designed casting system is checked again for the boundary conditions of the undercut-free laminate body, and the representations of the individual layers are exported as. dxf files.

The installation space required by the rotation of the component 100 and the designed casting system is also calculated. This results in an installation space of 1200×800×800 mm³. The result for this component 100 is a vertical layer division having 21 layers. Each laminate body 300 is uniquely identified in the form 201 of a layer number. The bridge system is cast upright, cut from the inside and fed.

For logistical reasons, the digital representations of the laminate bodies are clustered according to layer numbers and sent to the production system. Seven layers each form a cluster and are positioned one after the other for the manufacturing process according to increasing layer height.

Quartz sand is used as the basic molding material. The connection between the grains of sand is ensured by a self-hardening chemical system based on furan resin. The standard dimensions of a laminate body 300 are 1200 mm×800 mm as a basic dimension, the height being individualized depending on the calculated height of the individual laminate bodies. The production system can produce laminate bodies up to 10 cm high in an endless process. Loose basic molding material, the particles of which have already been coated with a chemical binder, is placed on the conveyor belt and pre-smoothed using a doctor blade.

A roller 700 compacts the molding material layer 300 and simultaneously creates the required layer height. Excess material can fall down to the left and right of the conveyor belt. Directly behind the roller 700, the endless band of molding material is cut at the edges by means of band saws to the installation space width of 800 mm. Once the required length has been reached, the conveyance stops and the laminate body 300 is cut to size using a movable saw. The process sequence runs intermittently in layers.

The laminate bodies of a cluster are virtually sorted from the smallest to the greatest layer thickness and produced from the smallest to the greatest layer thickness. Layer height transitions between two layers are implemented using a linear method in the vertical direction of the roller 700. Thus, when there is a transition of two layer thicknesses/laminate body heights, there is a linear increase in the thickness of the blanks. The laminate bodies harden to a firmness within a running meter on the conveyor belt, so that mechanical handling is possible without damaging the laminate bodies.

While blank layers are still being produced on the material input side on the production machine, the endless layer is divided into individual layers over a length of 1200 mm on the outgoing side of the machine using the movable band saw. The wedge-shaped connecting pieces between two laminate bodies having different layer heights are also separated by means of the movable saw system.

Laminated bodies having a basic dimension of 1200 mm×800 mm are now present, the layer heights varying between the laminate bodies 300. The conveyor belt pushes the laminate bodies onto a roller conveyor arranged at right angles to the first belt. The separated layer transitions are ejected to the side in front of the roller conveyor and fed back into the regeneration cycle.

While the laminate bodies on the first conveyor belt were still sorted according to increasing layer height, they are now sorted directly in the order of their individual layer number and position in the final casting mold when they are placed on the roller conveyor. This can be done by displacing the laminate bodies that are already located on the roller conveyor. If, for example, the laminate bodies having layer numbers 3 and 7 are already on lying the roller conveyor, then layer number 6 would be placed directly between the two already lying laminate bodies, and the laminate body having layer number 1 would be placed to the left of layer number 3.

The laminate bodies now lie having standardized basic dimensions and at an individual height from left to right in ascending layer number/position number on the roller conveyor.

A computer-controlled milling machine is installed on the left-hand side of said roller conveyor, which milling machine can mill 2D geometries and, as an additional degree of freedom, can also swivel the milling head with an end mill 600. The laminate bodies are positioned on the milling table according to the layer number, and the individual milled groove of the required cavities/recesses in the laminate body 300 present in each case is carried out. The released molding material dust is extracted directly from above and below, and burrs are removed directly from the edges of the laminate bodies via trailing chains. As a result, no further cleaning effort is required on the laminate bodies 300, and after a successful milling process said laminate bodies can be lifted off by a robot using a pneumatic suction gripper. Seven laminate bodies each are tied up on a Euro pallet as a package and form a shipping unit.

The molding material that is left over as waste from the manufacturing process and the molding material residues from the manufacturing process of the blanks are directly shredded and regenerated.

The twenty-one laminate bodies are delivered in the form 201 of three Euro pallets to the customer foundry, which can stack the laminate bodies directly on top of one another using its indoor crane and add weights. The subsequent casting process does not differ from conventional sand casting processes.

Aspects of the invention follow, each of which can represent independent inventions individually, but also together or individually or in groups together with patent claims of this application.

1. Aspect: A method for producing articles by a casting process, characterized in that the casting mold is composed of layers which are produced and structured outside of the space in which they are assembled into the casting mold.

2. Aspect: The method for producing articles by a casting method according to aspect 1, characterized in that the layers are structured using a subtractive method.

3. Aspect: The method for producing articles by a casting process according to aspect 1 or 2, characterized in that the layers are essentially free of undercuts perpendicular to their plane of extension.

4. Aspect: The method for producing articles by a casting process according to aspect 1, 2 or 3, characterized in that layers of different thicknesses can be used for producing the casting mold.

5. Aspect: The method for producing articles by a casting process according to aspects 1 to 4, characterized in that the machining is carried out by mechanical machining methods such as milling, drilling, sawing, eroding, ultrasonic machining, laser cutting, plasma cutting, water jet cutting, punching, fine cutting.

6. Aspect: The method for producing articles by a casting process according to any one of aspects 1 to 5, characterized in that the machining is carried out in the still unbound state by suction, scraping, milling or similar processes.

7. Aspect: The method for producing articles by a casting process according to any one of aspects 1 to 6, characterized in that the layers consist of metals, ceramics, plastics or natural materials.

8. Aspect: The method for producing articles by a casting process according to any one of aspects 1 to 7, characterized in that the layers are formed from solids, particulate materials, suspensions, emulsions, dispersions, slips, aerosols.

9. Aspect: The method for producing articles by a casting process according to any one of aspects 1 to 8, characterized in that quartz sand, artificial sand, mullite, rutile sand, chrome ore sand, kerphalites, cerabeads, glass beads, ceramic particles, ceramic powders, steel particles, aluminum particles, copper particles, particles made of copper alloys, metallic particles, plastic particles or granulates or natural material particles or granulates are used as particle material.

10. Aspect: The method for producing articles by a casting process according to any one of aspects 1 to 9, characterized in that the particles are bound into a layer by means of an adhesive force consisting of chemical bonding, physical drying, magnetic interaction, electrostatic interaction or the effect of gravity.

11. Aspect: The method for producing articles by a casting process according to any one of aspects 1 to 10, characterized in that binding clay, furan resin binders, cold-box binders, waterglass-based binders, phenolic resin-based binders, PEP SET binders, molding material or kernel oils, acrylic resin binders or other adhesive systems are used as binders.

12. Aspect: A device for carrying out a method according to any one of aspects 1 to 11.

13. Aspect: A mold for a cast component which was produced according to a method according to any one of aspects 1 to 11.

### REFERENCE NUMBERS

100 component/cast part
200 mold cavity
201 mold (upper box)
202 core
203 pouring basin and gate
204 mold (lower box)
300 layer
400 layer (changed layer thickness)
401 layer (thick layer thickness)
600 milling cutter
601 vertical milled grooves
602 angled milling cutter
603 angled milled groove
604 milled groove having steps within one layer
605 milling cutter for machining the bottom
700 smoothing roller
701 shot nozzle
702 smoothed layer
704 press for layer compaction
705 shot nozzle
706 striker plate
707 compressed air with molding material
708 sand-free air escapes through nozzles
800 base plate
900 weighting
901 ladle
902 melt
1000 low tensioners
1100 layers having different orientation
1200 layer for vertical installation

1. A method for producing a casting mold, the method comprising initially separately producing from one another at least three laminate bodies of the casting mold, and then joining together the laminate bodies into one or more stacks and into the casting mold.

2. The method according to claim 1, wherein the laminate bodies formed such that, after assembly into the casting mold, at least two of the laminate bodies surround a cavity of the casting mold to be filled with a casting material in an annular manner.

3. The method according to claim 1, wherein the laminate bodies are formed such that at least two of the laminate bodies each have at least one opening which completely penetrates the laminate body and is surrounded by a circumferential laminate body wall.

4. The method according to claim 1, wherein the laminate bodies are aligned when they are joined together into a stack by one of (1) being on a common alignment body or and (2) by interlocking projections and recesses provided on each of the laminate bodies.

5. The method according to claim 1, wherein the laminate bodies are connected to one another at adjacent boundary surfaces when the laminate bodies are assembled into a stack and have one of (1) the same layer thickness and (2) different layer thicknesses in a stacking direction.

6. The method according to claim 5, wherein the laminate bodies connected to one another when they are joined together by at least one of gluing, welding, a force-fit connection, and a form-fit connection.

7. The method according to claim 1, wherein
the laminate bodies produced by one of an extrusion process, a rolling process, a casting process, a core shooting process, and an additive manufacturing process.

8. The method according to claim 1, wherein the laminate bodies are produced as solid bodies and that a recess penetrating the bodies is then made in the laminate bodies.

9. The method according to claim 1, wherein recesses penetrating the laminate bodies are made in the laminate bodies means of at least one of a subtractive process, a punching process, a laser cutting process, a water cutting process, and a chemical process.

10. The method according to claim 1, wherein the laminate bodies are shaped as one of disks and plane-parallel plates.

11. The method according to claim 1, wherein surfaces of the laminate bodies of a stack which adjoin adjacent laminate bodies coplanar.

12. The method according to claim 1, wherein each of the laminate bodies free of undercuts in a stacking direction.

13. The method according to claim 12, wherein the laminate bodies are joined together such that, in the stacking direction, at least one undercut is provided in a cavity of the casting mold to be filled with a casting material and is formed by an interface of a laminate body.

14. The method according to claim 1, wherein a model of the casting mold is divided into layers one after the other in different stacking directions and the stacking direction having the smallest number of undercuts is selected so that all undercuts at the interfaces lie between each two layers.

15. A casting mold produced by the method according to claim 1.

16. The method according to claim 1, wherein producing the laminate bodies comprises initially separately producing more than ten laminate bodies.

17. The method according to claim 2, wherein the laminate bodies are formed such that, after assembly into the casting mold, each laminate body except for the end laminate body of a stack, surrounds the cavity of the casting mold to be filled with the casting material in the annular manner.

18. The method according to claim 3, wherein the laminate bodies are formed such that each laminate body, except for the end laminate body of a stack, have the at least one opening which completely penetrates the laminate body and is surrounded by the circumferential laminate body wall.

19. The method according to claim 9, wherein the subtractive process comprises a cutting process.

20. The method according to claim 14, wherein the stacking direction having the smallest number of undercuts is selected and the layer thicknesses of the laminate bodies are then divided so that all undercuts at the interfaces lie between each two layers.
